(19) United States
(12) Patent Application Publication
(10) Pub. No.: US 2002/0114666 A1
(43) Pub. Date: Aug. 22, 2002

(54) Unit structure part of scafflold pipes

(76) Inventors: Kazuo Uchida, Tokyo (JP); Masamichi Ishigami, Tokyo (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 09/788,644

(22) Filed: Feb. 21, 2001

(51) Int. Cl. F16B 1/00; B25G 3/36; E04G 7/00

(52) U.S. Cl. 403/401

(57) ABSTRACT

A unit structure part of scaffold steel pipes are disclosed, including an L-shaped unit structure part 21, a T-shaped unit structure part 31, a normal 3-direction unit structure part 32, a cross-shaped unit structure part 33, a normal 6-direction unit structure part 34, a T-shaped joint member 35, a cross-shaped joint member 42 and/or a normal 4-direction joint member 45, all of which are of a same outer diameter and of a same material with those of a scaffold steel pipe and may be optionally used in combination with scaffold steel pipes 22 and joint members 23 which may be available in the market, thereby to construct a structure of optional shape.

### BACKGROUND OF THE INVENTION

1. Field of the Invention

The present invention relates to a unit structure part of scaffold steel pipes, and more particularly relates to the unit structure part including an L- or (-shaped unit structure part, a T-shaped unit structure part, a normal 3-direction unit structure part, a cross-shaped unit structure part, a normal 6-direction unit structure part, a T-shaped joint member, a cross-shaped joint member and/or a normal 4-direction joint member, all of which are produced by use of a scaffold steel pipe of a diameter of approximately 50 mm which is generally available in the market, and all of which are of a same outer diameter and of a same material with those of the scaffold steel pipe. The unit structure parts and joint members may be optionally used in combination with the scaffold steel pipes and joint members which may be generally available in the market to construct a structure of an optional shape which may be easily transported as so many pieces in broken condition, the structure to be constructed including a guard rail, a railing, a handrail, legs for a table, a stand or rest or the like which may be constructed easily and at a low cost.

2. Prior Art

It has been generally known that the scaffold steel pipes of a diameter of approximately 50 mm which are generally available in the market are optionally combined by means of fixed and/or adjustable typed cramp members to construct the structures of various types including railings, handrails and the like. The prefabricated structure may be easily transported in pieces to an optional place where the structure is constructed by use of the pieces. Further since a structure is easily constructed, the scaffold steel pipes and the cramp members are generally used at a construction working place and/or at home.

The scaffold steel pipes are normally connected by use of two types of cramp members which are of a fixed type for connecting two scaffold steel pipes normal to each other and of an adjustable type for connecting two scaffold steel pipes at optional angels.

In reference to FIGS. 13 and 23, in case the scaffold steel pipes 1 are connected to construct a structure 4 by use of a cramp member 3, the two scaffold steel pipes 1 are crossed normal to each other and are connected by use of a fixed-or adjustable-type of cramp member 3 which has a pair of opposite bolts 5 and nuts 6 for fastening the two scaffold steel pipes 1 individually. It is, therefore, apparent that the distance L1 between the longitudinal axes of the two scaffold steel pipes 1 is a dimension which is a total of a diameter D of one scaffold steel pipe 1 plus the intermediate part of the cramp member 3, and the total width L2 of the structure 4 is L1 plus the dimensions of two laterally extended bolts 5. More precisely, the dimension L2 is a total of the diameters of two scaffold steel pipes 1, the intermediate part of the cramp member 3 and the dimensions of two laterally extended bolts 5. Namely the length L2 is about three times as long as the diameter D of one scaffold steel pipe 1, that is, about 3D=15 cm. Thus the pipe connection in this way requires a broad space and is further apparently ugly detracting the scene of the place.

Further since the two bolts 5 are laterally projected from the cramp member 3, the passers-by may happen to contact the bolts 5 and may be hurt. Further in case the structure 4 is used as a railing for a parking place, it may happen that the trunk part of a car body 10 collides the bolt 5 before the bumper 9 comes to contact scaffold steel pipe 1. Thus the structure 4 may often hurt the car 8 which uses the parking place.

Such a problem exists in other cases of the guide railings, guard rails and the like temporarily or permanently constructed in the streets. These structures having the projections are dangerous especially to those who are old aged, visually handicapped and to the toddling babies and/or cycling children, and have been remained to be improved.

For the purpose of reducing such a danger, plastic protection covers (not shown)have been covered to the cramp members 3. However, a tremendous number of covers are required for all of the cramp members which are used on such structures at the streets, and therefore, require a considerably high cost. Further such covers may be easily disconnected and not enough to reduce the danger. Moreover, such covers unnecessarily occupy the space.

As to the joint members which are generally available in the market, the joint members have been originally used only to connect the scaffold steel pipes straight and have limited scope of usage of the scaffold steel pipes.

### OBJECTS OF THE INVENTION

The invention has been provided to eliminate the defects and disadvantages of the prior art. It is, therefore, a primary object of the invention to provide a unit structure part including an L-or <-shaped unit structure part, a T-shaped unit structure part, a normal 3-direction unit structure part, a cross-shaped unit structure part, a normal 6-direction unit structure parts, a T-shaped joint member, a cross-shaped joint member and/or a normal 4-direction joint member, all of which are formed by use of scaffold steel pipes and are of a same outer diameter and of a same material with those of the scaffold steel pipes and used in combination with joint members which are generally available in the market for connecting the scaffold steel pipes straight for the purpose of constructing a structure of scaffold steel pipes of optional type including a guard rail, a railing or a fence for defining a boundary around a construction working place, a parking place, a ranch, and/or a farm, a framework for forming a wall, a bridge extended across a stream and so on.

It is another object of the invention to provide a unit structure part easily and at a low cost.

It is another object of the invention to provide a unit structure part which may connect the scaffold pipes without any projections extending from the connected part of the scaffold pipes.

It is another object of the invention to provide a unit structure part which is used in combination with the scaffold steel pipes to construct an enclosure which may define a smart and ample space.

It is another object of the invention to provide a unit structure part which may be used to construct a smooth, smart and beautiful structure of scaffold steel pipes easily and at a low cost.

It is another object of the invention to provide a unit structure part which may be used in combination with the scaffold steel pipes to easily construct a structure which may be easily broken into pieces.

It is another object of the invention to provide a unit structure part of a scaffold steel pipe having an outer diameter 48.6 mm and a thickness 2.6 mm and having neck potions of at least 85 mm.

### SUMMARY OF THE INVENTION

Namely, the invention relates to a unit structure part of scaffold steel pipes including an L-shaped unit structure part, a T-shaped unit structure part, a normal 3-direction unit structure part, a cross-shaped unit structure part, a normal 6-direction unit structure part, a T-shaped joint member, a cross-shaped joint member and/or a normal 4-direction joint member, all of which are of a same outer diameter and of a same material with those of a scaffold steel pipe and may be optionally used in combination with scaffold steel pipes and joint members which may be available in the market, thereby to construct a structure of optional shape.

### BRIEF DESCRIPTION OF THE DRAWINGS

FIGS. 1 to 12 relate to the invention, wherein;

FIG. 1 is a perspective view of an L-shaped unit structure part of the invention which is made of a scaffold steel pipe.

FIG. 2A is a front elevational view of the scaffold steel pipe;

FIG. 2B is a front elevational view of the scaffold pipe cut apart with a cut section 45° to provide a neck of a minimum length of the L-shaped unit structure part;

FIG. 2C is an enlarged plan elevational view of the scaffold steel pipe cut apart with a cut section 45°;

FIG. 2D is a plan elevational view of the scaffold steel pipe cut apart with a cut section 45° and connected by welding to each other to form the L-shaped unit structure part;

FIG. 2E is a plan view of the L-shaped unit structure part of the invention made in the process of FIG. 2D;

FIG. 3 is a perspective view of the L-shaped unit structure part and a joint member which are used in combination to connect scaffold steel pipes to form an L-shaped portion of a structure to be constructed with the scaffold steel pipes;

FIG. 4 is a perspective view of a standing signboard constructed by use of the scaffold steel pipes;

FIG. 5 is a side elevational view of the standing signboard shown partly in vertical section;

FIG. 6 is a perspective view of a T-shaped unit structure part of the invention;

FIG. 7 is a perspective view of a normal 3-direction unit structure part of the invention;

FIG. 8 is a perspective view of a cross-shaped unit structure part and a normal 6-direction unit structure part of the invention, the latter being shown as having one direction pipe with imaginary lines;

FIG. 9 is a plan elevational view of the cross-shaped unit structure part shown partly in lateral section;

FIG. 10 is a perspective view of a storehouse constructed by use of combination of the normal 3-direction unit structure part, joint members and the scaffold steel pipes;

FIG. 11 is a perspective view of the scaffold steel pipes connected by use of one T-shaped unit structure part and three joint members;

FIG. 12 is a perspective view of a guard rail or fence constructed with the scaffold steel pipes by use of the unit structure parts and joint members of the invention and a car running nearby;

FIG. 13 is a perspective view of a part of guard rail or fence showing two scaffold steel pipes connected normal to each other by means of a conventional joint member.

FIGS. 14 through 22 relate to the embodiments of the invention, wherein;

FIG. 14 is a perspective view of a part of guard rail or fence showing two scaffold steel pipes connected to each other by means of the L-shaped unit structure part of the invention;

FIG. 15 is a plan elevational view of a railing or fence enclosing a parking place and cars parking therein, the railing or fence being constructed by use of the scaffold steel pipes and the unit structure parts of the invention;

FIG. 16 is a side elevational view of a part of railing or fence of a parking place partly shown in vertical section, the railing or fence having no projection which may hurt the body of car;

FIG. 17 is a perspective view of a T-shaped joint member of the invention;

FIG. 18 is a side elevational view of the T-shaped joint member of the invention partly sectioned to show the interior thereof;

FIG. 19 is a perspective view of one T-shaped joint member and one joint member which is generally available in the market which are used to connect three scaffold steel pipes;

FIG. 20 is a perspective view of one cross-shaped joint member of the invention and two joint members generally available in the market, one of which is partly shown, which are used to connect four scaffold steel pipes;

FIG. 21 is a perspective view of a normal 4-direction joint member of the invention showing a way for connecting the scaffold steel pipe;

FIG. 22 is a perspective view of a rectangular parallelepiped structure constructed with the scaffold steel pipes by use of the unit structure parts of the invention; and

FIG. 23 is a side elevational view of a part of railing or fence of a parking place, the railing or fence being constructed with the scaffold steel pipes which are connected by means of a cramp member having a projection which may hurt the body of car.

### DETAILED DESCRIPTION OF THE EMBODIMENTS

The invention will be described in detail in reference to the preferred embodiments as shown in the attached drawings.

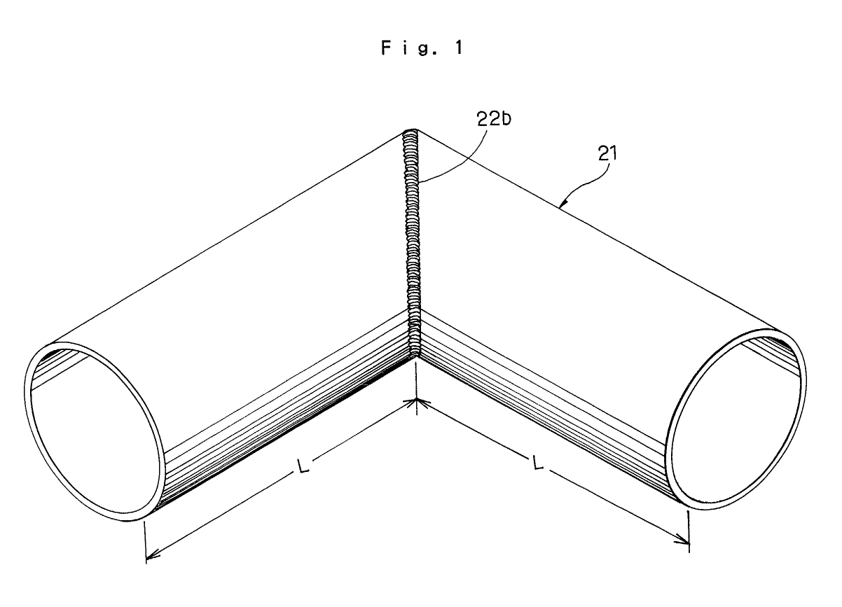

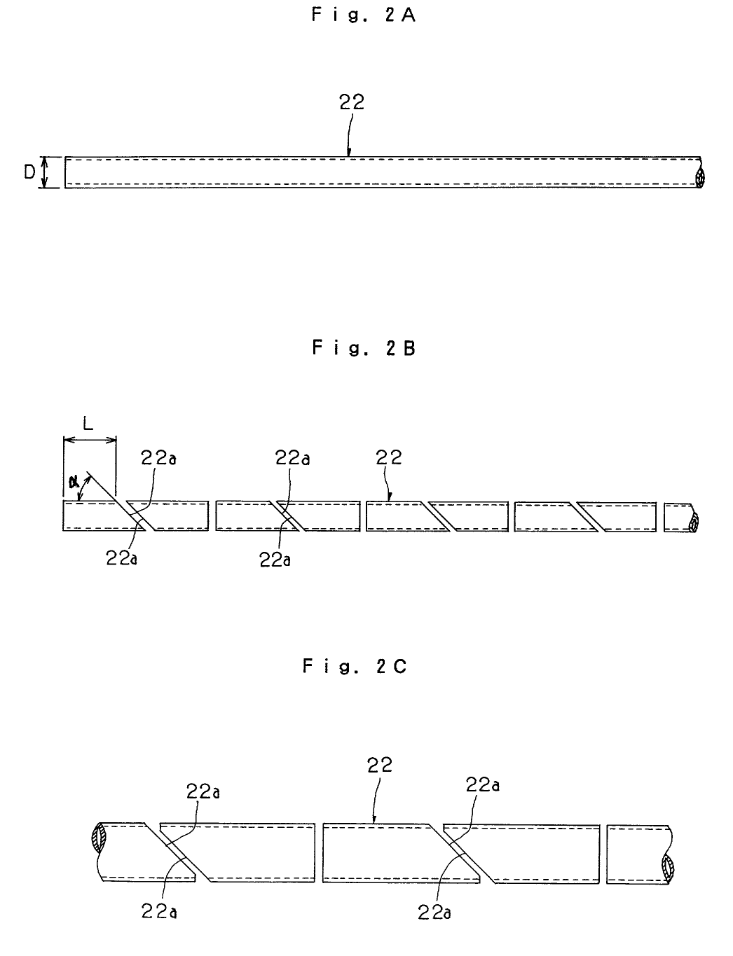

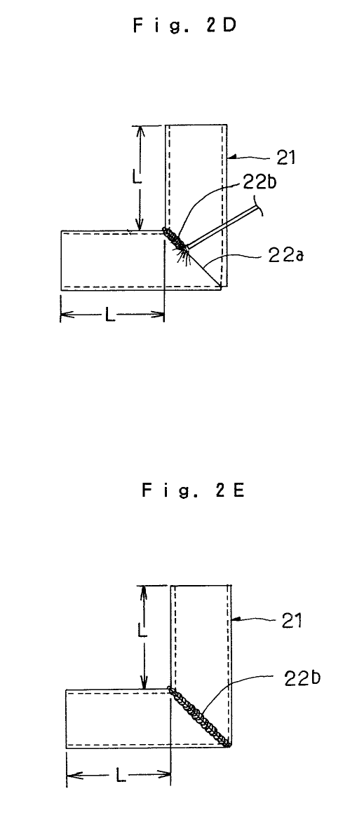

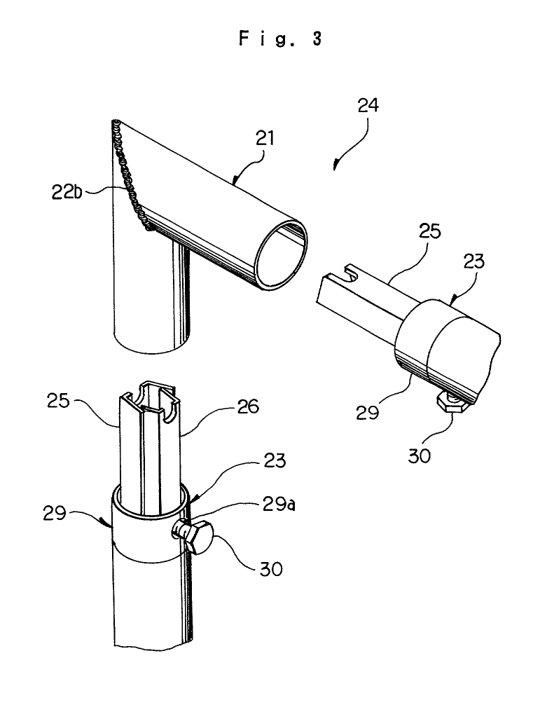

In FIGS. 1 through 5, an L-shaped unit structure part 21, which is one of the unit structure parts utilizing a scaffold pipe according to the invention and is shown by way of example, is generally L-shaped and is of an outer diameter of 48.6 mm with a thickness of 2.6 mm just like the scaffold steel pipes normally used at the working place of building construction. The L-shaped unit structure part 21 is used to form an L-shaped part of a structure 24 of optional shape which is constructed by use of a plurality of scaffold steel pipes 22. The L-shaped unit structure part 21 is produced, for example, by use of a scaffold steel pipe 22 of an outer diameter D as shown in FIG. 2A, the scaffold steel pipe 22 being cut to have an angle α and a minimum length L as shown in FIGS. 2B and 2C and the cut surfaces 22a being welded to each other with a welding material 22b to form the L-shaped unit structure part 21 into the L-shape or (-shape having the portions of a minimum length L as shown in FIGS. 2D and 2E, though the (-shape is not shown.

As shown in FIG. 3, joint members 23 which are available in the market are used to connect the scaffold steel pipes 22 straight to the L-shaped unit part 21. The joint member 23 is composed of a pipe 29 of a length 25 mm, a first connecting part 25 which is of a length 185 mm and is semicircular in vertical section, a second connecting part 26 which is of a length 185 mm and is semicircular in vertical section and a bolt 30, the second connecting part 26 having a female screw (not shown)secured to a central part thereof, the first and second connecting parts 25, 26 being arranged opposite to each other to form a hollow shaft and passed through the pipe 29 and the bolt 30 being inserted into the pipe 29 through a threaded hole 29a formed at the pipe 29 and brought into threaded engagement with the female screw of the second connecting part 26.

In order to connect the scaffold steel pipe 22 and the L-shaped unit part 21 by use of the joint member 32, the first and second connecting parts 25, 26 on one side of the pipe 29 are inserted into one pipe of the L-shaped unit part 21 and the first and second connecting parts 25, 26 on the opposite side of the pipe 29 are inserted into the scaffold steel pipe 22. The bolt 30 is threaded into the pipe 29 until the bolt 30 is pressed against the second connecting part 25. The bolt 30 is further rotated until the first and second connecting parts 25, 26 are separated from each other and are strongly pressed against the inner peripheral surface of the scaffold steel pipe 22 and of the pipe of the L-shaped unit part 21. Thus the scaffold steel pipe 22 and the L-shaped unit part 21 are firmly connected to each other.

In order to connect straight the scaffold steel pipe 22 which are available in the market by use of the joint member 32 which is also available in the market, it is preferable that the L-shaped unit part 21 is designed to have an outer diameter D of 48.6 mm, a cut angle α of 45° and a minimum length L of at least 85 mm which is required as a connecting dimension and is substantially equivalent to the length of the first and second connecting parts 25, 26 extended from the pipe 29. With the L-shaped unit part 21 of such dimensions and the cut angle being provided, the joint member 32 which is available in the market may be effectively utilized to construct various types of structures 24.

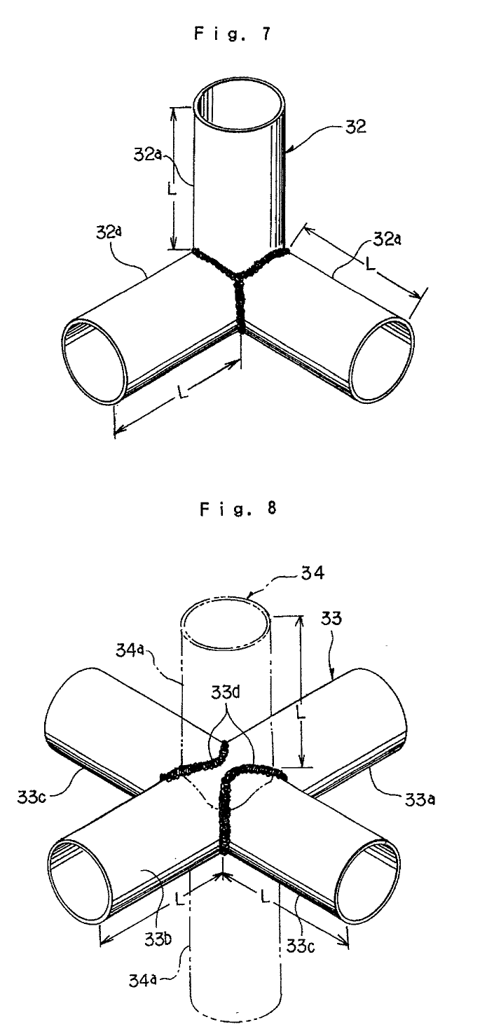

In FIG. 6, there is shown a T-shaped unit structure part 31 which is one of the unit structure parts utilizing a scaffold pipe according to the invention by way of example. The T-shaped unit structure part 31 is used to form a T-shaped structure part of a structure 24 of optional shape which is constructed by use of a plurality of scaffold steel pipes 22. The T-shaped unit structure part 31 is composed of a longer pipe 31a and a shorter pipe 31c which has one end welded to an outer peripheral portion 31b of the longer pipe 31a at the intermediate portion thereof, thereby to form the T-shape. The T-shaped unit structure part 31 has an outer diameter of 48.6 mm and has the necks, the length L of which is at least 85 mm as extending in three directions. Three joint members 23 may be inserted into the T-shaped unit structure part 31 at the three parts thereof respectively to connect the scaffold steel pipes 22 to the T-shaped unit structure part 31.

In FIG. 7, there is shown a normal 3-direction unit structure part 32 which is one of the unit structure parts utilizing a scaffold pipe according to the invention by way of example. The normal 3-direction unit structure part 32 is used to form a 3-direction intersection structure part of a structure 24 of optional shape which is constructed by use of a plurality of scaffold steel pipes 22. The normal 3-direction unit structure part 32 is composed of three pipes 32a having the necks of the length L respectively of 85 mm and being welded to one another to extend in three directions with 90° to one another.

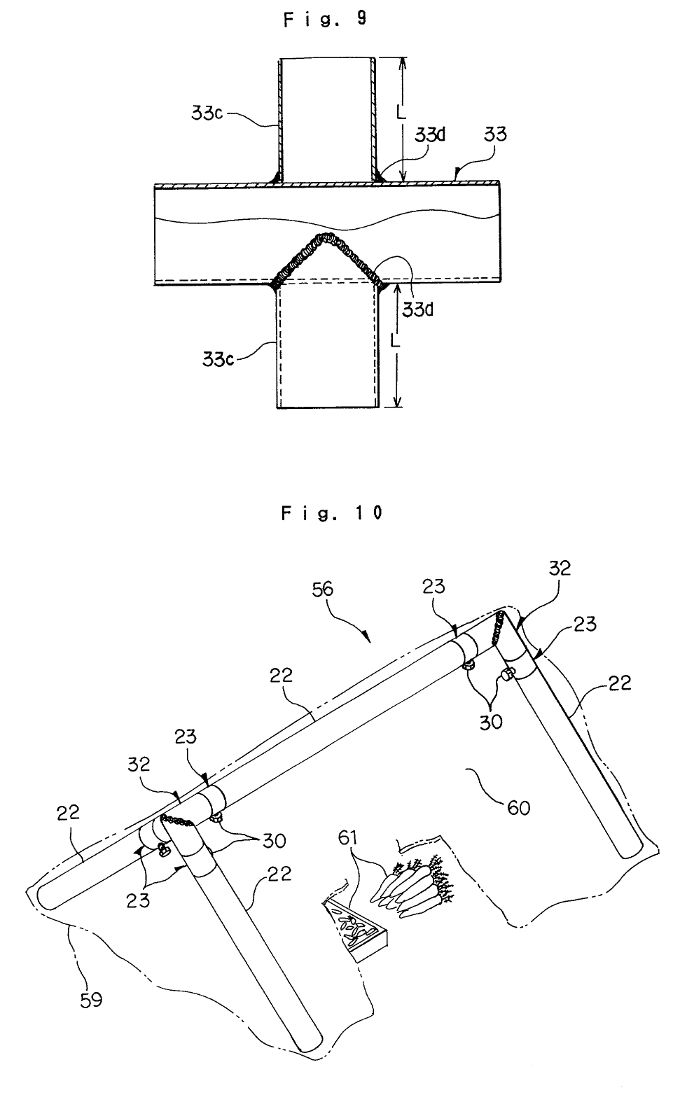

In FIGS. 8 and 9, there is shown a cross-shaped unit structure part 33 which is one of the unit structure parts utilizing a scaffold pipe according to the invention by way of example. The cross-shaped unit structure part 33 is used to form a cross intersection structure part of a structure 24 of optional shape which is constructed by use of a plurality of scaffold steel pipes 22. The cross-shaped unit structure part 33 is composed of a longer pipe 33a and two shorter pipes 33c each having one end oppositely welded with a welding material 33d to the outer periphery 33b of the longer pipe 33a at the intermediate portion thereof. Each of the pipes has a neck of the length L of 85 mm.

In FIGS. 8, there is shown a normal 6-direction unit structure part 34 which is one of the unit structure parts utilizing a scaffold pipe according to the invention by way of example, wherein two central shorter vertical pipes 34a are added to the cross-shaped unit structure part 33 as shown in broken lines. The normal 6-direction unit structure part 34 is used to form a 6-direction intersection structure part of a structure 24 of optional shape which is constructed by use of a plurality of scaffold steel pipes 22. The normal 6-direction unit structure part 34 is composed of six pipes welded to one another with 90° to extend in six directions. Each of the pipes has a neck of the length L of 85 mm.

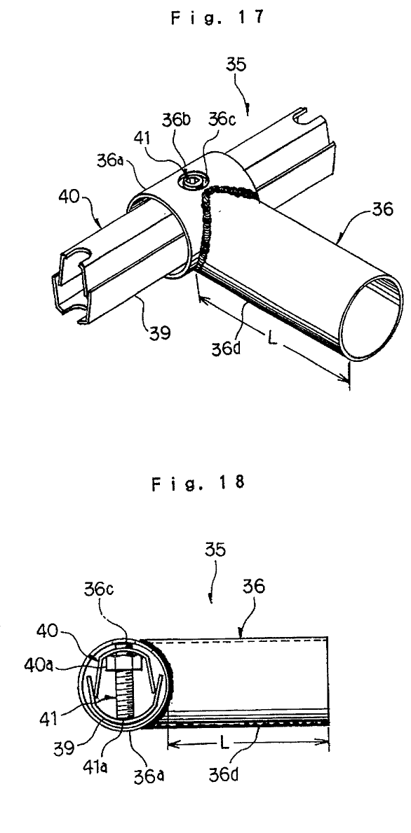

In FIGS. 17 through 19, there is shown a T-shaped joint member 35 which is one of the unit structure parts utilizing a scaffold pipe according to the invention by way of example. The T-shaped joint member 35 is composed of a shorter pipe 36a having an outer diameter which is identical with that of the scaffold steel pipe 22 and having a hole 36c formed at the periphery 36b thereof and a longer pipe 36d having a neck of the length L of 85 mm, the longer pipe 36d being welded to the outer periphery of the shorter pipe 36a to form a T-shaped unit structure part 36. The T-shaped joint member 35 is further composed of a first connecting part 39 which is semicircular in vertical section and a second connecting part 40 which is also semicircular in vertical section and has a female screw 40a secured thereto at an intermediate part thereof and a bolt 30, the first and second connecting parts 39, 40 being arranged opposite to each other to form a hollow shaft and passed through the shorter pipe 36a and the bolt 41 being inserted into the shorter pipe 36a through the hole 36c and brought into threaded engagement with the female screw 40a.

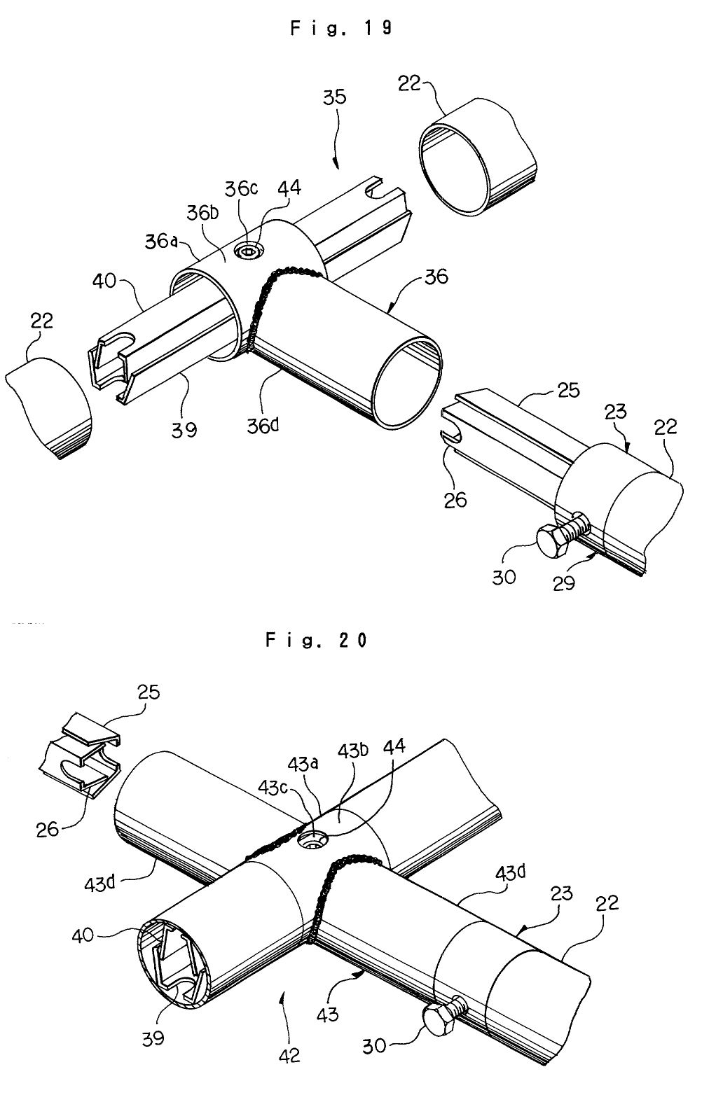

The bolt 41 is rotated to press the lower end thereof against the first connecting part 39. The bolt 41 is further rotated to separate the second connecting part 40 from the first connecting part 39. Thus with use of one joint member 29 which is generally available in the market and is provided with the bolt corresponding to the bolt 41, the scaffold steel pipes 22 may be connected to one another in a shape of T as shown in FIG. 19. In this way, the T-shaped joint member 35 may be used to easily construct a guard rail or a handrail at a considerably low cost.

In FIG. 20, there is shown a cross-shaped joint member 42 which is one of the unit structure parts utilizing a scaffold pipe according to the invention by way of example. The cross-shaped joint member 42 is composed of a shorter pipe 43a having a hole 43c formed at the periphery 43b thereof and two longer pipes 43d each having a neck, the length L of which is 85 mm, the two longer pipes 43d being welded opposite to each other to the outer periphery of the shorter pipe 36a to form a cross-shaped unit structure part 43. The cross-shaped joint member 42 is further composed of a first connecting part 39 which is semicircular in vertical section and a second connecting part 40 which is also semicircular in vertical section and has a female screw 40a secured thereto at an intermediate part thereof and a hexagon-holed hollow set bolt 44, the first and second connecting parts 39, 40 being arranged opposite to each other to form a hollow shaft and passed through the shorter pipe 43a and the bolt 44 brought into threaded engagement with the female screw 40a through the hole 43c.

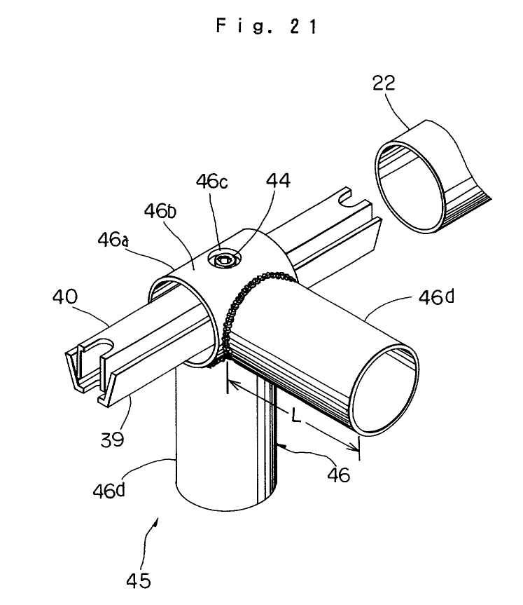

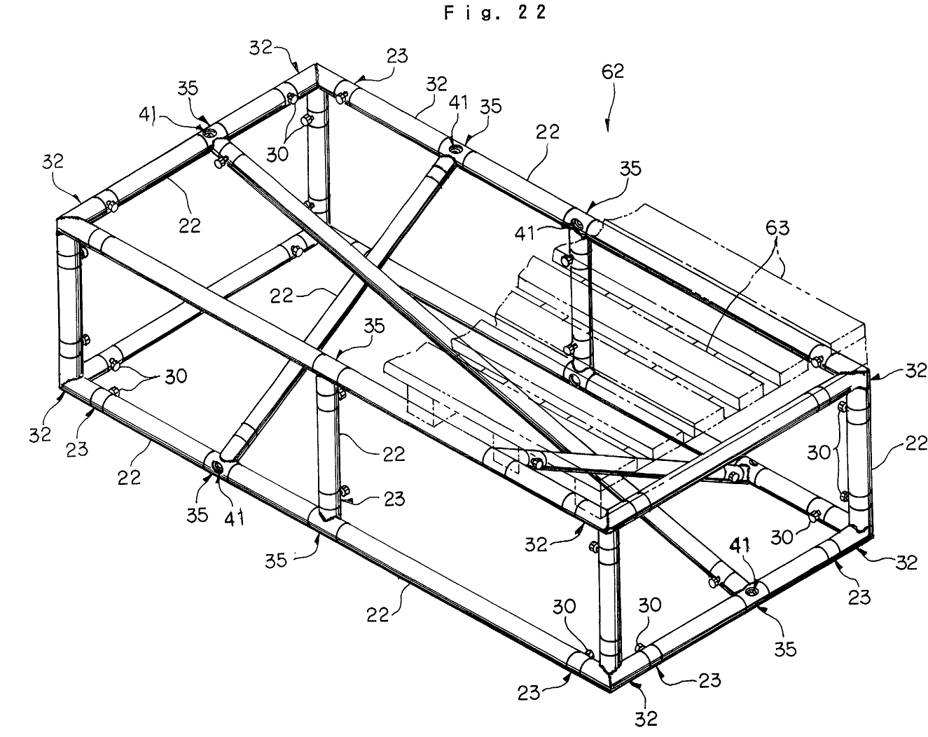

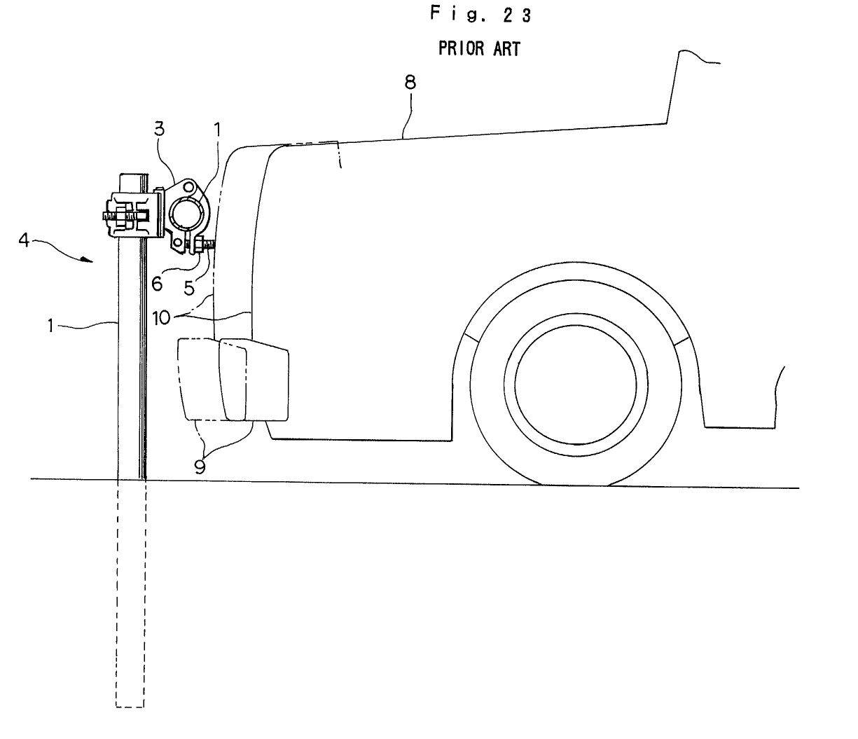

In FIG. 21, there is shown a normal 4-direction joint member 45 which is one of the unit structure parts utilizing a scaffold pipe according to the invention by way of example. The cross-shaped joint member 42 is composed of a shorter pipe 46a having a hole 46c formed at the periphery 46b thereof and two longer pipes 46d each having a neck, the length L of which is 85 mm, the two longer pipes 43d being welded to the outer periphery 46b of the shorter pipe 46a with 90° to each other to form a normal 4- direction unit structure part 46. The normal 4-direction joint member 45 is further composed of a first connecting part 39 which is semicircular in vertical section and a second connecting part 40 which is also semicircular in vertical section and has a female screw 40a secured thereto at an intermediate part thereof and a hexagon-holed hollow set bolt 44, the first and second connecting parts 39, 40 being arranged opposite to each other to form a hollow shaft and passed through the shorter pipe 46a and the bolt 44 brought into threaded engagement with the female screw 40a through the hole 46c.

In FIG. 22, there is shown a rectangular parallelepiped structure 62 which may be constructed by optional use of the scaffold steel pipes 22, the joint members 23, the normal 3-direction unit structure parts 32, the T-shaped unit A structure parts 31 or the T-shaped joint members 35. The normal 3-direction unit structure parts 32 are used at the eight corners of the rectangular parallelepiped structure 62. The scaffold steel pipes 22 are used at the twelve crest lines of the rectangular parallelepiped structure 62 and are connected to the normal 3-direction unit structure parts 32 by means of the joint members 23 respectively. The T-shaped unit structure parts 31 or the T-shaped joint members 35 are used opposite to each other at the joint parts between the scaffold steel pipes 22 while the scaffold steel pipes 22 are connected between the opposite T-shaped unit structure parts 31 or the T-shaped joint members 35 by means of the joint members 23 respectively.

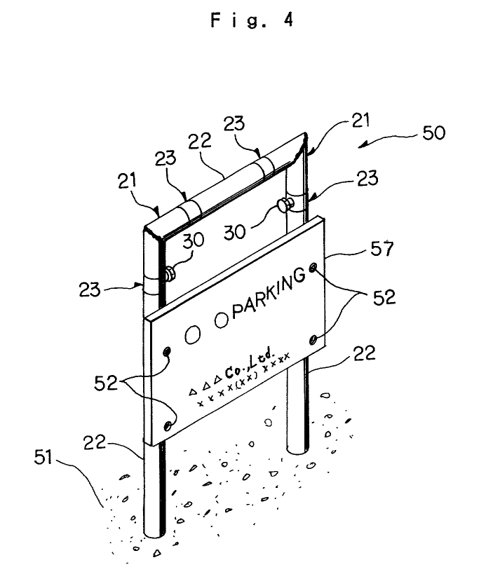

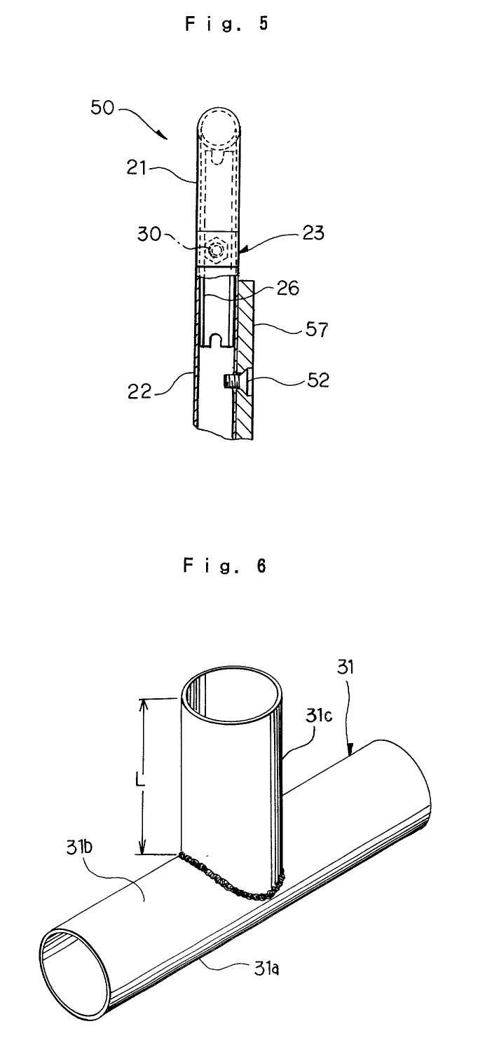

With the invention being so structured as described hereinbefore, the usage of the invention will be described in detail. In reference to FIGS. 4 and 5, in case a standing signboard 50 is constructed, the first and second connecting parts 25, 26 of each joint member 23 on one side thereof are inserted into each of the opposite openings of a scaffold steel pipe 22 which is cut in an optional length while the first and second connecting parts 25, 26 of each joint member 23 on the opposite side thereof are inserted into one end of each L-shaped unit structure part 21. The bolt 30 of each joint member 23 is then rotated to move the first and second connecting parts 25, 26 away from each other until the first and second connecting parts 25, 26 away from are strongly pressed against the inner surface of the scaffold pipe 22 and of each L shaped unit structure part 21, thereby to form a U-shaped member.

Subsequently the first and second connecting parts 25, 26 of each joint member 23 on one side thereof are inserted into each of the upper openings of two scaffold steel pipes 22 fixedly implanted in the ground 51 with a predetermined space provided therebetween while the first and second connecting parts 25, 26 of each joint member 23 on the opposite side thereof are inserted into the other end of each L shaped unit structure part 21. The bolt 30 of each joint member 23 is then rotated to move the first and second connecting parts 25, 26 away from each other until the first and second connecting parts 25, 26 away from are strongly pressed against the inner surface of each scaffold pipe 22 and of each L-shaped unit structure part 21, thereby to form a railing. A signboard 57 may be secured to the railing by means of screws 52(tapping screws are preferable). Thus a rigid standing signboard 50 may be constructed.

By the way, the scaffold steel pipes 22, the joint members 23 and the L-shaped unit structure parts 21 may be easily transported as so many small pieces to a place where the standing signboard 50 is constructed. Further the size of railing may be easily varied simply by changing the length of the scaffold steel pipes 22 in dependence upon the space where the standing signboard 50 is constructed. Further the bolts 30 may be directed to extend to inside of the railing, thereby to provide a smoothly outlined standing signboard 50 which is not harmful to the passers-by.

Further with application of the railing for the standing signboard 50, those who have no special skill may easily construct a wall or an enclosure around a house o something to be shut off from the outside. Since the railing of the scaffold steel pipes 22 may be formed as being smooth at the outside thereof and may provide a smooth plane, the crosspieces of wood may be appropriately fixed to the railing, and then the boards of wood may be attached to the crosspieces in a manner that the scaffold steel pipes 22 may be hidden by the boards of wood. Thus a smart wall or an enclosure may be constructed isolating the interior from the outside. Instead of the boards of wood, the waved metal boards or the waved boards of synthetic resin may be used for reduction of cost.

Though not shown, a prefabricated structure of a series of square frames may be formed by use of the scaffold steel pipes 22 as a simplified bridge girder on which thick waterproof veneers are fixedly placed for the purpose of crossing over a gutter or a stream. Thus a thin but rigid bridge may be constructed. By the way, in case the scaffold steel pipes 22 are connected to form the bridge girder by use of the cramp members which are available in the market, the bridge girder will be three times as thick as the one formed by use of the joint members of the invention. Further as the scaffold steel pipes 22 are generally galvanized with a thick layer, the pipes will not be easily rusted due to the humidity affected from the stream. The bridge will, therefore, be reliably used for a long time.

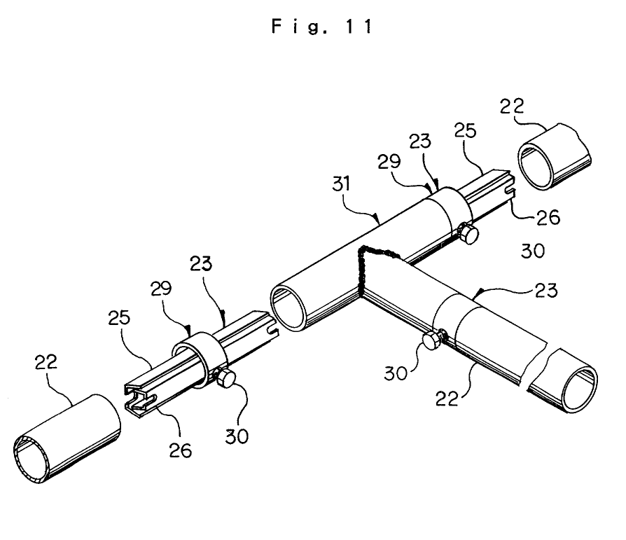

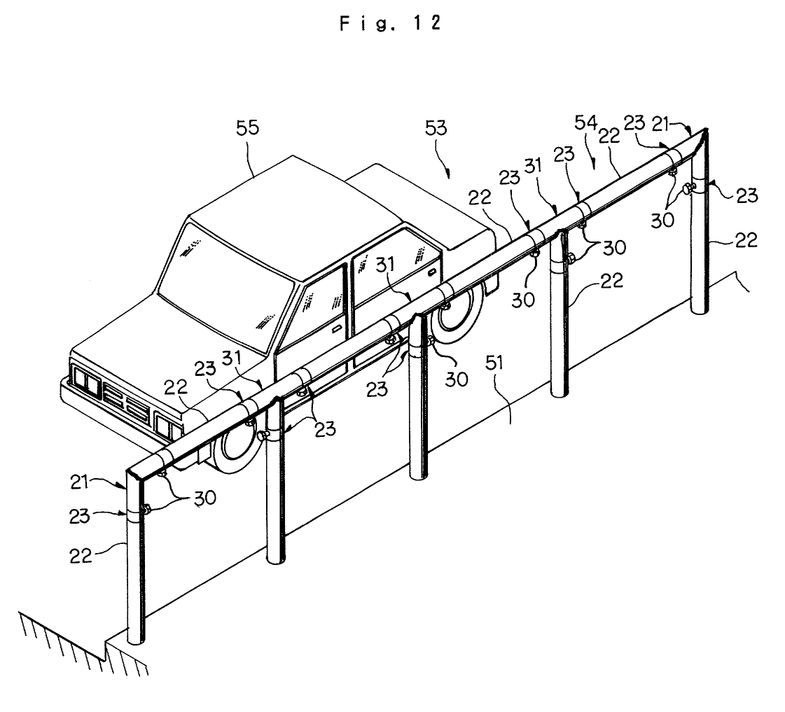

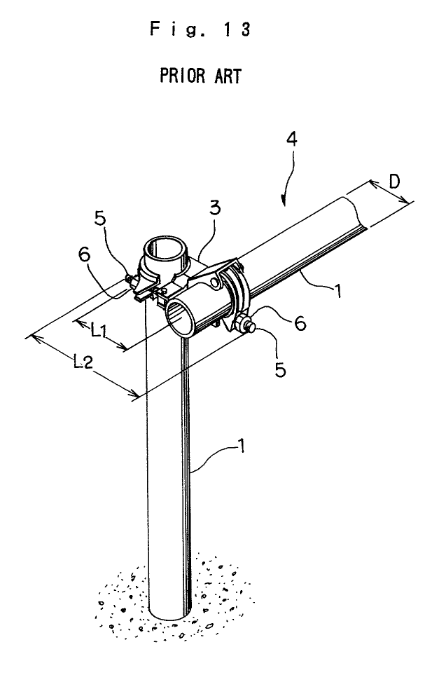

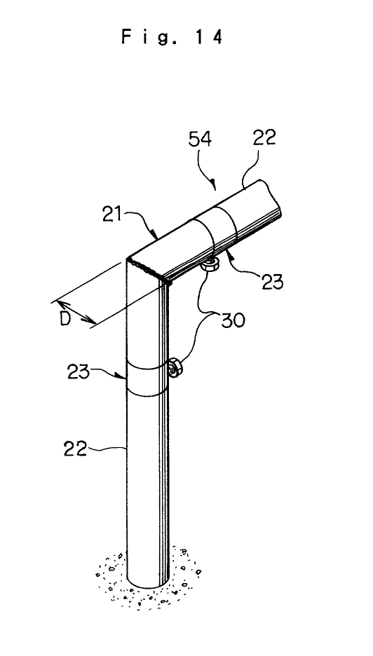

In reference to FIGS. 11 through 16, a comparatively long railing 54 for a parking place and the like may be constructed by use of the scaffold steel pipes 22. The railing 54 is composed of a pair of opposite end scaffold steel pipes 22 fixedly implanted in the ground with a predetermined space therebetween and a plurality of scaffold steel pipes 22 extended between the end scaffold steel pipes 22 by means of the L-shaped unit structure parts 21. The railing 54 is further composed of a plurality of scaffold steel pipes 22 for reinforcing the railing 54, the plurality of scaffold steel pipes 22 being fixedly implanted in the ground with a predetermined space therebetween between the end scaffold steel pipes 22, and each being connected at the upper end thereof to the scaffold steel pipes 22 extending between the end scaffold steel pipes 22 by means of the T-shaped unit structure parts 31 and the joint members 23.

The bolts 30 may be fastened as all being directed to the inside of the scaffold steel pipes 22 of the diameter D. The railing 54 is, therefore, free of any outer projections which may otherwise give damage to cars or give hurt to men, and is enable the car drivers and passers-by to utilize the roadway and a sidewalk so broad because the width of railing 54 is within 50 mm which is the value of diameter of scaffold steel pipes 22. Further the railing 54 of scaffold steel pipes 22 may be utilized as guard rails painted with an optional color, for example, white to match a scene of streets. Further the railing 54 may be utilized as the protection railing at a construction workplace adjacent a road without detraction of the view of street or of safety of passers-by. Thus the railing 54 of scaffold steel pipes 22 may be utilized in many ways almost limitlessly.

For example, the railing 54 may be utilized as a handrail at an event place or tourist resort place for the people gathering there or may be utilized as a railing for enclosing a ranch or for guiding or regulating the activities of animals in the ranch.

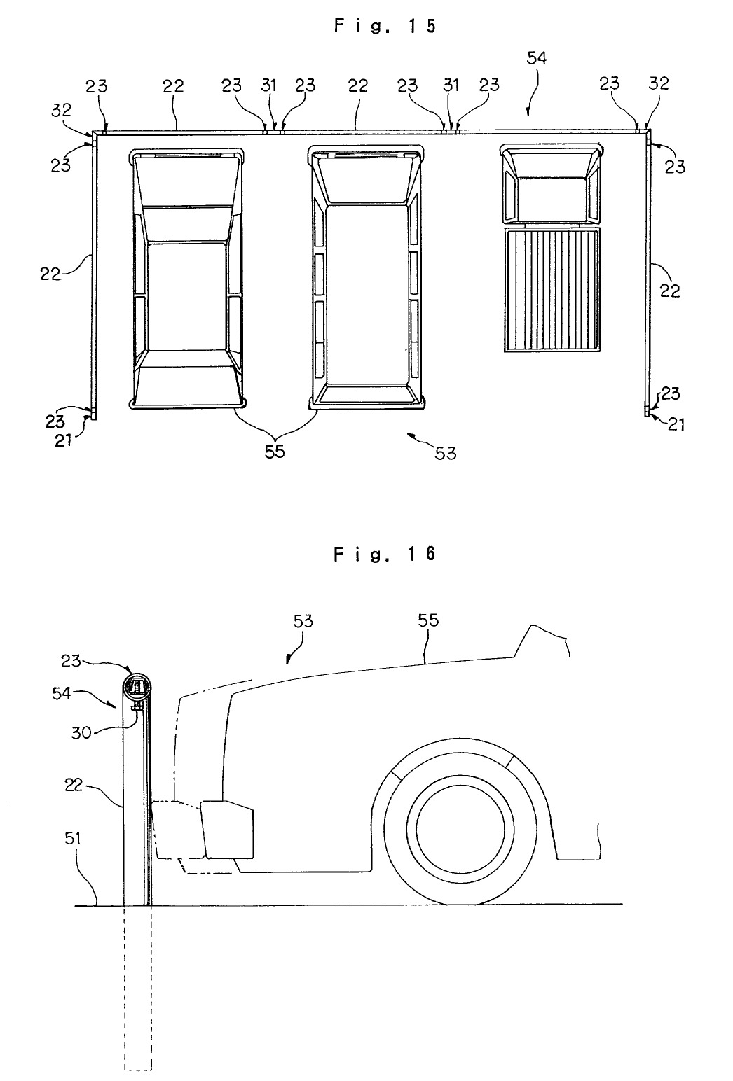

As shown in FIG. 15, the railing 54 used as an enclosure of a parking place is actually very simplified and beautiful without any outer projections, the maximum width being within 50 mm, that is, the diameter D of the scaffold steel pipes 22 contributing to obtain a so broad parking space. Further as shown in FIG. 16, in case a car 53 happens to contact a scaffold steel pipe 22, for example, one of the vertical scaffold steel pipes 22, of the railing 54, the bumper of car will be first to contact the scaffold steel pipe 22 and therefore, the body 55 of car will not be damaged. The driver is not required to take a special care of the car when parking.

In reference to FIG. 10, a prefabricated storehouse structure 56 of the invention is composed of a pair of normal 3-direction unit structure parts 32 connected to each other with one scaffold steel pipes 22 and two joint members 23 and having four scaffold steel pipes 22 of a same length connected thereto respectively by means of four joint members 23, thereby to form a mountain-like structure. The mountain-like structure is covered with a sheet 59 to form a tent 60. The tent 60 may be used at a farm to temporarily store agricultural products 61. Further the prefabricated storehouse structure 56 is of light weight and therefore, may be easily moved to an optional place.

Further the leg pipes 22 of the storehouse structure 56 may be optionally elongated to form a prefabricated tent or a tent house for temporal use by people in case of a disaster. Further since the tent is triangular, the strength is secured against the wind and/or rain or earthquake.

In FIG. 22, there is shown a rectangular parallelepiped structure 62. The rectangular parallelepiped structure 62 is composed of so many scaffold steel pipes 22, joint members 23, normal 3-direction structure parts 32, T-shaped unit structure parts 31 and T-shaped joint members 35, wherein the normal 3-direction structure parts 32 are used at the eight corners and the scaffold steel pipes 22 are used as twelve crest lines connected between the normal 3-direction structure parts 32 by means of the joint members 23.

In case of reinforcing the rectangular parallelepiped structure 62, the T-shaped unit structure parts 31 or the T-shaped joint members 35 are arranged at the intermediate portions of optional scaffold steel pipes 22 oppositely extending in parallel with each other and the T-shaped unit structure parts 31 or the T-shaped joint members 35 are connected with the scaffold steel pipes 22 respectively, hereby to provide so many normal and diagonal beams. The reinforced rectangular parallelepiped structure 62 may have a board 63 attached to the top thereof such that the structure 62 may be used as a stand, a table or a rest. Further the rectangular parallelepiped structure 62 may be used as the legs of verandah. Those who have no special skill may easily construct a rigid and beautiful verandah by use of the rectangular parallelepiped structure 62 at a low cost:

In FIGS. 17 through 21, there are shown T-shaped joint members 35, cross-shaped joint members 42 and normal 4-direction joint members 45, some of which are already incorporated with the joint member 23. With use of these members 35, 42, 45, three scaffold steel pipes 22 may be connected with a fewer number of joint members 23 per each of the members 35, 42, 45, actually fewer by two compared in case of using the T-shaped unit structure part 31 and the cross-shaped unit structure part 33. Further each of the members 35, 42, 45 is provided with a hexagon-holed hollow set bolt 44 which is completely housed within the diameter D of the scaffold steel pipes 22. It is, therefore, apparent that a smooth and safe structure which is free of any projections may be constructed.

In case the structure of scaffold steel pipes 22 has been not needed, the structure may be broken into pieces simply by loosening the bolts 30 or the hexagon-holed follow set bolts 44 and may be easily transported away. These pieces may be used again for constructing another type of structure.

The invention being thus described, it will be obvious that the same may be varied in many ways. Such variations are not regarded as a departure from the spirit and scope of the invention, and all such modifications are intended to be included within the scope of the following claims.

What is claimed is:

1. A unit structure part of scaffold pipes including an L-shaped unit structure part or (-shaped unit structure part characterized by being used in combination with at least one joint member for connecting scaffold steel pipes straight and having neck portions of a minimum length substantially equivalent to a length of connecting portion of said joint member.

2. The unit structure part as defined in claim 1, wherein said L-shaped unit structure part is composed of two pipes which are of a same outer diameter and of a same material with those of a scaffold steel pipe, and being used in combination with at least one joint member having a connecting part of a predetermined length for connecting scaffold steel pipes straight, said two pipes being each cut to have a cut section of 45° and being connected to each other with said cut section of 45° of one of said two pipes being welded to said cut section of 45° of the other of said two pipes such that said two pipes form an L- shaped structure having neck portions of a minimum length substantially equivalent to the length of said connecting part of said joint member.

3. The unit structure part as defined in claim 2, wherein said L-shaped unit structure part is composed of two pipes of an outer diameter of 48.6 mm and of a thickness of 2.6 mm.

4. A unit structure part of scaffold pipes including a T-shaped unit structure part characterized by being composed of a longer pipe and a shorter pipe, all of which are of a same outer diameter and of a same material with those of a scaffold steel pipe and being used in combination with at least one joint member having a connecting part of a predetermined length for connecting scaffold steel pipes straight, said shorter pipe being connected by welding to said longer pipe at an outer periphery of thereof to form a T-shaped structure having three neck portions which are longer than the length of said connecting part of said joint member.

5. The unit structure part as defined in claim 4, wherein said T-shaped unit structure part is composed of two pipes of an outer diameter of 48.6 mm and of a thickness of 2.6 mm.

6. A unit structure part of scaffold pipes including a normal 3-direction unit structure part characterized by being composed of three pipes, all of which are of a same outer diameter and of a same material with those of a scaffold steel pipe, and being used in combination with at least one joint member having a connecting part of a predetermined length for connecting scaffold steel pipes straight, said three pipes being connected one another by welding to form a normal 3-direction unit structure part having said three pipes extending with an angle 90° being provided therebetween and having neck portions of a length longer than the length of said connecting part of said joint member.

7. The unit structure part as defined in claim 6, wherein said normal 3-shaped unit structure part is composed of three pipes of an outer diameter of 48.6 mm and of a thickness of 2.6 mm.

8. A unit structure part of scaffold pipes including a cross-shaped unit structure part characterized by being composed of one longer pipe and two shorter pipes, all of which are of a same outer diameter and of a same material with those of a scaffold steel pipe, and being used in combination with at least one joint member having a connecting part of a predetermined length for connecting scaffold steel pipes straight, said two shorter pipes being connected by welding in a manner as being opposite to each other to said longer pipe at an outer periphery thereof to form a cross-shaped unit structure part having four pipe portions extending as so many neck portions which are longer than the length of said connecting part of said joint member.

9. The unit structure part as defined in claim 8, wherein said cross-shaped unit structure part is composed of three pipes of an outer diameter of 48.6 mm and of a thickness of 2.6 mm.

10. A unit structure part of scaffold pipes including a normal 6-direction unit structure part characterized by being composed of one longer pipe and four shorter pipes, all of which are of a same outer diameter and of a same material with those of a scaffold steel pipe, and being used in combination with at least one joint member having a connecting part of a predetermined length for connecting scaffold steel pipes straight, said four shorter pipes being connected by welding to said longer pipe at an outer periphery thereof with an angle of 90° being provided therebetween to form a normal 6-direction unit structure part having six pipe portions extending as so many neck portions which are longer than the length of said connecting part of said joint member.

11. The unit structure part as defined in claim 10, wherein said normal 6-direction unit structure part is composed of five pipes of an outer diameter of 48.6 mm and of a thickness of 2.6 mm.

12. A unit structure part of scaffold pipes including a T-shaped joint member characterized by being composed of a T-shaped unit structure part comprising a longer pipe and a shorter pipe, all of which are of a same outer diameter and of a same material with those of a scaffold steel pipe, and being used in combination with at least one joint member having a connecting part of a predetermined length for connecting scaffold steel pipes straight, said shorter pipe having a hole formed at the outer periphery thereof and said longer pipe having one end thereof connected by welding to said shorter pipe at the outer periphery thereof and extending as a neck portion which is longer than the length of said connecting part of said joint member, thus to form a T-shaped unit structure part; a first connecting member of a predetermined length which is semicircular in vertical section; a second connecting member of a predetermined length which is semicircular in vertical section and has a female screw secured thereto at an intermediate portion thereof, said first and second connecting members being arranged opposite to each other to form a hollow shaft which is inserted into said shorter pipe; and a bolt inserted into said shorter pipe at said hole thereof and brought into threaded engagement with said female screw.

13. The unit structure part as defined in claim 12, wherein said T-shaped joint member is composed of two pipes of an outer diameter of 48.6 mm and of a thickness of 2.6 mm.

14. A unit structure part of scaffold pipes including a cross-shaped joint member characterized by being composed of a cross-shaped unit structure part comprising one shorter pipe and two longer pipes, all of which are of a same outer diameter and of a same material with those of a scaffold steel pipe, and being used in combination with at least one joint member having a connecting part of a predetermined length for connecting scaffold steel pipes straight, said shorter pipe having a hole formed at the outer periphery thereof and said longer pipes being connected by welding to said shorter pipe at the outer periphery of thereof and extending as so many neck portions which are longer than the length of said connecting part of said joint member, thus to form a cross-shaped unit structure part; a first connecting member of a predetermined length which is semicircular in vertical section; a second connecting member of a predetermined length which is semicircular in vertical section and has a female screw secured thereto at an intermediate portion thereof; said first and second connecting members being arranged opposite to each other to form a hollow shaft which is inserted into said shorter pipe; and a bolt inserted into said shorter pipe at said hole thereof and brought into threaded engagement with said female screw.

15. The unit structure part as defined in claim 14, wherein said cross-shaped joint member is composed of three pipes of an outer diameter of 48.6 mm and of a thickness of 2.6 mm.

16. The unit structure part as defined in claim 14, wherein said bolt is a hexagon-holed hollow set screw which is entirely housed within said shorter pipe and may be accessed from the outside through said hole.

17. A unit structure part of scaffold pipes including a normal 4-direction joint member characterized by being composed of a normal 4-direction unit structure part comprising one shorter pipe and two longer pipes, all of which are of a same outer diameter and of a same material with those of a scaffold steel pipe, and being used in combination with at least one joint member having a connecting part of a predetermined length for connecting scaffold steel pipes straight, said shorter pipe having a hole formed at the outer periphery thereof and said two longer pipes being connected by welding to said shorter pipe at the outer periphery of thereof and extending as so many neck portions with an angle of 90° being provided therebetween with a length which is longer than the length of said connecting part of said joint member; a first connecting member of a predetermined length which is semicircular in vertical section; a second connecting member of a predetermined length which is semicircular in vertical section and has a female screw secured thereto at an intermediate portion thereof; said first and second connecting members being arranged opposite to each other to form a hollow shaft which is inserted into said shorter pipe; and a bolt inserted into said shorter pipe at said hole thereof and brought into threaded engagement with said female screw.

18. The unit structure part as defined in claim 17, wherein said cross-shaped joint member is composed of three pipes of an outer diameter of 48.6 mm and of a thickness of 2.6 mm.

19. The unit structure part as defined in claim 17, wherein said bolt is a hexagon-holed hollow set screw which is entirely housed within said shorter pipe and may be accessed from the outside through said hole.

20. A structure including a railing comprising a first group of vertical scaffold steel pipes implanted in the ground in alignment with a predetermined space provided therebetween, each of said pipes having an opening at the upper end thereof, a first group of joint members each composed of a pipe part, a first connecting part of a predetermined length which is semicircular in vertical section, a second connecting part of a predetermined length which is semicircular in vertical section and has a female screw secured thereto and a bolt to be brought into threaded engagement with said female screw, said first and second connecting parts being arranged opposite to each other to form a hollow shaft and being inserted into said pipe part, each of said joint members being connected to each of said vertical scaffold steel pipes by inserting said first and second connecting parts on one side of said pipe part into each upper opening of said vertical scaffold steel pipes, a pair of L-shaped unit structure parts, one of which being connected to said first and second connecting parts of said joint member on the other side of said pipe part at a vertical scaffold steel pipe located at one end side of said vertical scaffold steel pipes and the other of which being connected to said first and second connecting parts of said joint member on the other side of said pipe part at another vertical scaffold steel pipe located at the opposite end side of said vertical scaffold steel pipes, a plurality of T-shaped unit structure parts each having a pipe portion connected to said first and second connecting parts of said joint member on the other side of said pipe part at each of said vertical scaffold steel pipes located between said opposite end sides, a second group of scaffold steel pipes horizontally arranged between said vertical scaffold steel pipes located at the opposite end sides and connected to said L-shaped unit structure parts and said T-shaped unit structure parts, and a second group of joint members of a same type with said first group of joint members for connecting said second group of scaffold steel pipes to said L-shaped unit structure parts and said T-shaped unit structure parts, said bolts being rotated to move said first and second connecting parts in the direction away from each other to press the same against the inner periphery of each scaffold steel pipe.

21. A structure including a prefabricated storehouse comprising a pair of normal 3-direction unit structure parts, a predetermined number of scaffold steel pipes including at least one scaffold steel pipe connected between said pair of normal 3-direction unit structure parts and the other scaffold steel pipes having one end thereof connected to said pair of normal 3-direction unit structure parts respectively, thereby to form a mountain-like structure, a predetermined number of joint members for connecting said plurality of scaffold steel pipes to said pair of normal 3-direction unit structure parts and a sheet for covering said mountain-like structure.

22. A structure including a rectangular parallelepiped structure comprising a first group of scaffold steel pipes for forming said rectangular parallelepiped structure having eight corners, a plurality of normal 3-direction unit structure parts for forming said eight corners of said rectangular parallelepiped structure, a second group of scaffold steel pipes for forming beams extending between two of said first group of scaffold steel pipes which are arranged opposite to each other diagonally and/or in a same plane, a plurality of T-shaped unit structure parts or T-shaped joint members for connecting said second group of scaffold steel pipes between said two of said first group of scaffold steel pipes which are arranged opposite to each other diagonally and/or in a same plane, and a plurality of joint members for connecting said first group of scaffold steel pipes and said normal 3-direction unit structure parts and for connecting said T-shaped unit structure parts or T-shaped joint members and said T-shaped unit structure parts or T-shaped joint members.
